(19) United States
(12) Patent Application Publication
(10) Pub. No.: US 2022/0004995 A1
(43) Pub. Date: Jan. 6, 2022

(54) SYSTEM AND METHOD FOR RECRUITING RESOURCES USING PERSONALITY BASED MATCHING PLATFORM

(71) Applicant: Enrole Inc., Castle Rock, CO (US)

(72) Inventors: Adarsh Pachori, Castle Rock, CO (US); Neelagreev Griddalur, Castle Rock, CO (US); Aishwarya Suresh, Castle Rock, CO (US); Aarti Vellimedu, Castle Rock, CO (US)

(21) Appl. No.: 17/367,770

(22) Filed: Jul. 6, 2021

Related U.S. Application Data
(63) Continuation of application No. 63/048,244, filed on Jul. 6, 2020.

(51) Int. Cl. G06Q 10/10; G06Q 10/06; G06N 20/00

(52) U.S. Cl. CPC G06Q 10/1053; G06N 20/00; G06Q 10/063112

(57) ABSTRACT

The present invention relates to a system and method for recruiting resources using a personality-based matching platform. The system comprises of a cloud server computer, a database unit, a system processing unit, a talent user device, and a recruiter device. The present invention comprises of the cloud server computer having, the database unit that is used to store computer-readable instructions that automatically improves the matching algorithum by learning through the data of talent users and the data of recruiters. The system processing unit executes computer-readable instructions and displays the suitable profile cards on the talent device touch screen and on the recruiter device touch screen. Both the talent user and the recruiter approve each others by swiping each other profile cards and after approval from both the talent user and recruiter, both parties are able to converse over the in-built message application and proceed further for completing the recruitment.

### FIELD OF INVENTION

The present invention relates to a recruitment system, and method and more specifically relates to a personality-based matching recruitment system and method for electronic management of recruiting talent.

When recruiting, companies/organizations expend considerable effort to attract talented individuals (‘talent’) to provide the largest possible pool of talent from which to choose the most suitable individual or individuals for a particular role or roles. Common methods of recruiting or raising awareness of vacancies include advertising in print or online or outsourcing the process to a specialist recruitment firm. The recruiting processes have been developed and refined further since the use of social media and digital databases became commonplace and widespread.

Many recruiters simply start by finding and using a job posting previously used by his/her company, say at least once before, or the recruiter may instead search online for what other companies are posting for similar job openings. The job description may request an applicant to submit a resume and his/her salary requirements, but often not much else. Consequently, the recruiter is left to wade through a pile of job applications trying to determine who is truly qualified, has the appropriate job experience, can handle the level of responsibilities required, lives within a reasonable commuting distance for the work location, is available when needed, fits the company's culture and is willing to work within the salary budget that has been allocated.

After the job opening has been posted for some time and applicants have inquired, comes the daunting and quite time-consuming task of trying to contact each applicant who appears qualified to schedule either a phone interview and/or an in-person interview. Consequently, the current hiring systems can cause even highly qualified applicants to be lost to a company's competitors, simply because of highly inefficient ways and means to qualify applicants, and the employer's own delayed communications with qualified applicants.

Today's hiring practices also suffer from the lack of time available to assess each Applicant. Consequently, many Applicants get ruled out before the interview process even begins. Further, the time-consuming process of trying to interview Applicants fairly with, say the same questions from the same people under similar circumstances becomes virtually impossible. Even if several Applicants all get interviewed with the same questions, having different people doing the interviewing can create subjective differences and challenges to later fairly comparing similarly qualified Candidates.

There are several patent applications all around the world that are working on recruiting talent virtually. These include U.S. Pat. No. 8,572,000B1 which discloses a terminal may be configured to display a list of recruiting events. In response to the selection of one of the recruiting events, the terminal may be configured to display a list of a plurality of candidates associated with the selected one of the recruiting events. The terminal may be configured to select one of the said candidates from the list of candidates based on an identifier read, by the terminal, from a computing device associated with the selected candidate. The terminal may be configured to, subsequent to the selection of the candidate, display a profile of the selected candidate. The terminal may be configured to display an interactive form via which a user of the terminal can input an assessment of the selected particular candidate.

Patent application U.S. Pat. No. 8,015,048B2 discloses a system for matching entities having needed to entities having the capability to meet the needs. A plurality of needs profiles are created, where each need profile comprises a data record specifying attributes about a need. A plurality of capability profiles is also created, where each capability profile comprises a data record specifying a set of attributes of an entity having the capability of meeting a need. A matching engine is coupled to repetitively and automatically examine the needs profiles and capability profiles to identify matched profiles, wherein a match comprises a set of profiles judged to be substantially compatible based upon the correspondence of the attributes specified therein.

Other publications in the art include U.S. Pat. No. 8,112,365B2, which describes a system and method for online employment recruiting and evaluation; U.S. Pat. No. 7,945,554B2 discloses a system and methods for providing enhanced job searching. Ideally, there would be a system that could interview virtually an unlimited number of Applicants with similar questions, criteria, and conditions, so as to create a relatively fair assessment for each unique opportunity and Job Opening. None of the prior inventions and/or applications is capable to overcome all the disadvantages and drawbacks.

It is within the aforementioned context that a need for the present invention has arisen. Thus, there is a need to address one or more of the foregoing disadvantages of conventional systems and methods, and the present invention meets this need.

### SUMMARY OF THE INVENTION

The present invention relates to a system and method for recruiting resources using a personality-based matching platform. The system includes a cloud server computer, a database unit, a system processing unit, a talent user device, and a recruiter device. The present invention includes the cloud server computer having, the database unit that is used to store computer-readable instructions and automatically improves the matching algorithum by learning through the data of talent users and the data of recruiters. The cloud server computer includes a system processing unit that executes computer-readable instructions. The talent user device and the recruiter device are used to store and execute computer-readable instructions and also communicate with the system processing unit of the cloud server computer. The talent user device and the recruiter device both have a touch screen feature.

In embodiments of the invention, the system processing unit executes computer-readable instructions and displays the suitable profile cards on the talent device touch screen and the recruiter device touch screen.

In the embodiments of the invention both the talent user and the recruiter approve each other by swiping each others profile cards on their respective screens and after approval from both the talent user and recruiter, both parties are able to converse over the in-built message application and proceed further for completing the recruitment process having one to one interaction between the talent user and the recruiter.

The present invention also relates to the system processing unit that executes an artificial intelligence-based computer-readable instruction to generate the talent user profile card and the recruiter profile card and further search for suitable recruiter profile card for the talent user device and talent user profile card for the recruiter device.

The main advantage of the present invention is that the present invention is able to recruit new talent based on the personality of the talent.

Yet another advantage of the present invention is that the present invention focuses on one to one interaction between the recruiter and the talent.

Yet another advantage of the present invention is that the present invention has a double-blind matching feature.

Yet another advantage of the present invention is that the present invention focuses on making personality as the front end of the recruiting process.

Yet another advantage of the present invention is that the present invention has intelligent message suggestions to make conversations easier.

Further objectives, advantages, and features of the present invention will become apparent from the detailed description provided herein below, in which various embodiments of the disclosed invention are illustrated by way of example.

### BRIEF DESCRIPTION OF THE DRAWINGS

The aforementioned aspects and other features of the present invention will be explained in the following description, taken in conjunction with the accompanying drawings, wherein:

FIG. 1 illustrates the connectivity of a Talent user device and a recruiter device with the system.

### OBJECTIVE OF THE INVENTION

The main objective of the present invention is to provide recruits based on the personality of the talent.

Another objective of the present invention is to provide one to one interaction between the recruiter and the talent.

Another objective of the present invention is to provide intelligent message suggestions that make the conversation easier.

Another objective of the present invention is to provide a different aspect of the talent user which is not normally presented on a resume.

Further objectives, advantages, and features of the present invention will become apparent from the detailed description provided herein below, in which various embodiments of the disclosed invention are illustrated by way of example and appropriate reference to accompanying drawings.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

Definition

The terms “a” or “an”, as used herein, are defined as one or as more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps, or acts are in some way inherently mutually exclusive.

As used herein, the term “one or more”; generally refers to, but not limited to, singular as well as a plural form of the term.

The drawings featured in the figures are for the purpose of illustrating certain convenient embodiments of the present invention and are not to be considered as limitation thereto. Term “means” preceding a present participle of operation indicates the desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

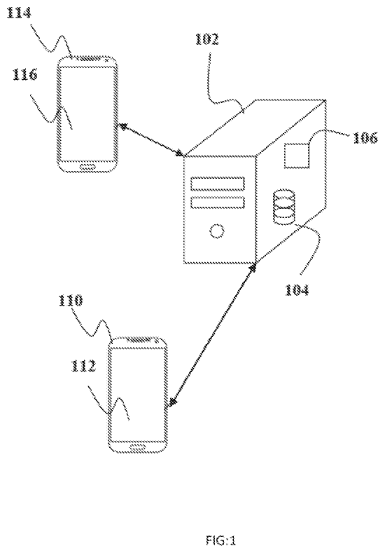

FIG. 1 illustrates a system(100) for recruiting resources using a personality-based matching platform. The system(100) includes a cloud server computer(102), talent user device(110) and one recruiter device(114). The cloud server computer(102) having a database unit(104), and a system processing unit(106) . The talent user device(110) stores computer-readable instructions that are executed by the talent user device(110) to communicate with the system processing unit(106) of the cloud server computer(102), the talent user device(110) having a talent device touch screen(112). The recruiter device(114) stores computer-readable instructions that are executed by the recruiter device(114) to communicates with the system processing unit(106) of the cloud server computer(102), the recruiter device(114) having a recruiter device touch screen(116).

The present invention relates to a system and method for recruiting resources using a personality-based matching platform. Herein, invention relates to a system and method of recruiting also includes holistic assessments of a candidate based on factors selected from , a technical scopes of the role, culture fit, etc.

In the present invention, the system includes a cloud server computer, a database unit, a system processing unit, a talent user device, and a recruiter device. The cloud server computer having, the database unit that is used to store computer-readable instructions that automatically improves the matching algorithum by learning through the data of talent users and the data of recruiters. The cloud server computer includes a system processing unit that executes computer-readable instructions stored in the database unit. The talent user device and the recruiter device are used to store and execute computer-readable instructions and also communicate with the system processing unit of the cloud server computer. The talent user device and the recruiter device both have a touch screen feature.

The data of talent user is stored in the database unit of the cloud server computer and the system processing unit uses the stored data of talent user as a variable to generate the talent user profile card on the talent user device and further based on the talent user profile card, the system processing unit executes computer-readable instructions to search for the suitable recruiters.

The data of recruiters are stored in the database unit of the cloud server computer and the system processing unit executes search for a recruiter out of the recruiters in the database unit to generate the recruiter profile card and as well as a recuiter company profile card, and based on the recruiter profile card and the recuiter company profile card, the system processing unit executes computer-readable instructions to search for the suitable talent user.

In the preferred embodiment, the system processing unit executes computer-readable instructions and displays the suitable profile cards and the recuiter company profile card on the talent device touch screen and on the recruiter device touch screen. Herein, both the talent user and the recruiter approve each other by swiping each others profile cards on their respective screens and after approval from both the talent user and recruiter, both parties are able to converse over the in-built message application and proceed further for completing the recruitment process, thus having one to one interaction between the talent user and the recruiter.

In the preferred embodiment of the present invention, the system processing unit executes an artificial intelligence-based computer-readable instruction to generate the talent user profile card the recruiter profile card and the recruiter company profile card, and search for a suitable recruiter profile card for the talent user device and the talent user profile card for the recruiter device.

In an embodiment the cloud server computer is including, but not limited to, a desktop computer, a server, a mainframe computer.

In an embodiment the talent user device and the recruiter device are including, but not limited to, a tablet, a smartphone, and a touch-based personal computer. In the preferred embodiment, the talent user device and the recruiter device are smartphones.

In an embodiment, the present invention relates to a method for recruiting resources using a personality-based matching platform. The method includes: A method of a talent user profile card generation, the method having:

a talent user creates a digital account on a cloud server computer with the help of a talent user device;

after the creation of the digital account, a talent device touch screen displays data that needs to be filled in order to generate the talent user profile card, wherein, the information includes but not limited to a profile picture of the user, university/company name, talent user university grade level(e.g freshman, sophomore, junior or senior), keywords that depict the personality of the user, the type of position the talent user is seeking;

the talent user fills up the information on a talent device touch screen and the talent user device communicates the talent user's data to be stored in the database unit of the cloud server computer; and

Further, the talent user is able to upload a 25-second elevator pitch video on the database unit; and

Thus, the system processing unit executes computer-readable instructions that use data of talent users as variables to generate the talent user profile card.

Herein, the system processing unit uses natural language processing to extract data from a 25-second elevator pitch video of the talent user and further uses that data to generate the talent user profile card.

A method of a recruiter profile card generation, the method having:

a recruiter creates a digital account on the cloud server computer with the help of the recruiter device;

after the creation of the digital account, the recruiter device touch screen displays data that needs to be filled in order to generate a recruiter profile card, wherein recruiter is able to generate multiple recruiter job profiles based on different job role requirements;

the recruiter device communicates recruiter's data to be stored in the database unit of the cloud server computer; and

the system processing unit executes computer-readable instructions that use data of recruiters to generate the recruiter profile card.

a method of a recruiter company profile card generation, the method having

a recruiter creates a digital account on an at least one cloud server computer with the help of an at least one recruiter device,

after creation of the digital account, a recruiter device touch screen display data that needs to be fill in order to generate a recruiter company profile card,

the at least one recruiter device communicates data of company to be stored in the at least one database unit of the at least cloud server computer, and

the system processing unit executes computer-readable instructions that uses data of company to generate the recruiter company profile card;

A method of finding a match between talent user and recruiter, the method having:

the system processing unit executes computer-readable instructions and displays a suitable recruiter profile card on the talent device touch screen, that matches with the talent user personality and skills;

further the system processing unit executes computer-readable instructions and displays the talent user profile card on the recruiter device touch screen based on the job role requirement;

both the talent user and the recruiter approve each other by swiping each others profile card on their respective screen and after approval from both the talent user and recruiter, both parties are able to converse over in-built message application and proceed further for completing the recruitment process, thus having one to one interaction between the talent user and the recruiter.

Herein, the system processing unit uses an artificial intelligence-based algorithm to search for a suitable recruiter profile card and the recruiter company profile card for the talent user device and vice versa.

In the preferred embodiment, the artificial intelligence-based algorithm uses skills, keywords, past experience, and industry to search for suitable recruiter profile cards and the recruiter company profile card; for the talent user device and search for suitable talent users profile cards for the recruiter device. In another embodiment, the card swiping pattern data is being used by the system processing unit of the cloud server computer to improve the artificial intelligence-based algorithm to search for suitable recruiter profile card for the talent user device and search for suitable the talent user profile card for the recruiter device. In another embodiment, a unique artificial intelligence-based algorithm is catered to the recruiter device that allows the recruiter to define the importance of the different factors for the recruiter to select the talent user and based on those factors, the algorithm is tweaked to allow matching of the talent user's profile card with important factors cited by the recruiter in the matching process.

In another embodiment the present invention relates to a system and method for recruiting resources using a personality-based matching platform. Herein, invention relates to a system and method of recruiting also includes holistic assessments of a candidate based on factors selected from , a technical scopes of the role, culture fit, etc.

The the present invention includes one or more cloud server computers, one or more database units, a system processing unit, one or more talent user devices, and one or more recruiter devices. The one or more cloud the server computers include the one or more database units that are used to store computer-readable instructions that automatically improves the matching algorithum by learning through the data of talent users and data of recruiters. The one or more cloud server computers include a system processing unit that executes computer-readable instructions. The one or more talent user devices and the one or more recruiter devices are used to store and execute computer-readable instructions and also communicate with the system processing unit of the one or more cloud server computer. The one or more talent user device and the one or more recruiter devices both have a touch screen feature.

The data of the talent user is stored in the one or more database units of the one or more cloud server computers and the system processing unit uses the stored data of talent user as a variable to generate the talent user profile card on the one or more talent user devices and further based on the talent user profile card, the system processing unit executes computer-readable instructions to search for the suitable recruiters.

The data of recruiters are stored in the one or more database units of the one or more cloud server computers and the system processing unit executes search for a recruiter out of the recruiters in the database unit to generate the recruiter profile card as well as the recruiter company profile card, and further based on the recruiter profile card, the system processing unit executes computer-readable instructions to search for the suitable talent user.

In the preferred embodiment, the system processing unit executes computer-readable instructions and displays the suitable profile cards and the recruiter company profile card on the talent device touch screen and on the recruiter device touch screen. Herein, both the talent user and the recruiter approve each other by swiping each others profile cards on their respective screens and after approval from both the talent user and recruiter, both parties are able to converse over the in-built message application and proceed further for completing the recruitment process, thus having one to one interaction between the talent user and the recruiter.

In the preferred embodiment of the present invention, the system processing unit executes an artificial intelligence-based computer-readable instruction to generate the talent user profile card, the recruiter profile card and the recruiter company profile card, and search for a suitable recruiter profile card for the one or more talent user devices and the talent user profile card for the one or more recruiter devices.

In an embodiment, the one or more cloud server computers are including, but not limited to, a desktop computer, a server, a mainframe computer.

In an embodiment, the one or more talent user devices and the one or more recruiter devices are including, but not limited to, a tablet, a smartphone, and a touch-based personal computer. In the preferred embodiment, the talent user device and the recruiter device are smartphones.

In an embodiment, the present invention relates to a method for recruiting resources using a personality-based matching platform. The method includes: a method of a talent user profile card generation, the method having:

a talent user create a digital account on one or more cloud server computers with the help of one or more talent user devices;

after the creation of the digital account, a talent device touch screen displays data that needs to be filled in order to generate the talent user profile card, wherein, the information includes but not limited to a profile picture of the user, university/company name, talent user university grade(e.g freshman, sophomore, junior or senior), keywords that depict the personality of the user, the type of position the talent user is seeking;

the talent user fills up the information on a talent device touch screen and the one or more talent user devices communicate the talent user's data to be stored in the one or more database units of the one or more cloud server computers; and

Further, the talent user is able to upload a 25-second elevator pitch video on the one or more database units; and

Thus, the system processing unit executes computer-readable instructions that use data of talent users as variables to generate the talent user profile card.

Herein, the system processing unit uses natural language processing to extract data from a 25-second elevator pitch video of the talent user and further uses that data to generate the talent user profile card.

In another embodiment, a method of a recruiter profile card generation, the method having

a recruiter creates a digital account on the one or more cloud server computers with the help of the one or more recruiter devices;

after the creation of the digital account, the recruiter device touch screen displays data that needs to be filled in order to generate a recruiter profile card, wherein recruiter is able to generate multiple recruiter job profiles based on different job role requirements;

the one or more recruiter devices communicate recruiter's data to be stored in the one or more database units of the one or more cloud server computers, and

the system processing unit executes computer-readable instructions that use data of recruiters to generate the recruiter profile card.

a method of a recruiter company profile card generation, the method having

a recruiter creates a digital account on one or more cloud server computers with the help of one or more recruiter devices,

after creation of the digital account, a recruiter device touch screen display data that needs to be fill in order to generate a recruiter company profile card,

the one or more recruiter devices communicate data of company to be stored in the one or more databases unit of the one or more server computers, and

the system processing unit executes computer-readable instructions that uses data of company to generate the recruiter company profile card;

A method of finding a match between talent user and recruiter, the method having:

the system processing unit executes computer-readable instructions to display a suitable recruiter profile card on the talent device touch screen, that matches with the talent user;s personality and skills;

further, the system processing unit executes computer-readable instructions and displays the talent user profile card on the recruiter device touch screen based on the job role requirement;

both the talent user and the recruiter approve each other by swiping each others profile card on their respective screen and after approval from both the talent user and recruiter, both parties are able to converse over in-built message application and proceed further for completing the recruitment process, thus having one to one interaction between the talent user and the recruiter.

Herein, the system processing unit uses an artificial intelligence-based algorithm to search for a suitable recruiter profile card and the recruiter company profile card for the one or more talent user devices and vice versa.

In the preferred embodiment, the artificial intelligence-based algorithm uses skills, keywords, past experience, and industry to search for suitable recruiter profile cards for the one or more talent user devices and search for suitable users profile cards for the one or more recruiter devices. In another embodiment, the card swiping pattern data is being used by the system processing unit of the one or more cloud server computers to improve the artificial intelligence-based algorithm to search for suitable recruiter profile card for the one or more talent user devices and search for suitable talent user profile card for the one or more recruiter devices. In another embodiment, a unique artificial intelligence-based algorithm is catered to the recruiter device that allows the recruiter to define the importance of the different factors for the recruiter to select the talent user and based on those factors, the algorithm is tweaked to allow matching of talent users profile card with important factors cited by the recruiter in the matching process.

In another embodiment, the present invention has an intelligent chatbox feature that helps the user's to improve their profile cards. The chatbox also provides suggestions based on the artificial intelligence algorithm which will look at all the factors of a user's profile. This artificial intelligence can include, but not limited to, systems that will process the elevator pitch video to determine the confidence and happiness levels of the person within the video to provide improvement feedback. It also will have the functionality where the user can ask for advice and the chatbot can provide suggestions. This will primarily be useful for inexperienced users as well as users who may be unaware of the dynamics of recruiting in the modern world or users who have simply never faced commercial recruiting processes.

In present embodiment, the present invention relates to provides a good match for the recruiter among the talent users based on personality, culture fit, soft skill, and experience. The match would be determined by the algorithm system only after the approval of the recruiter and the talent user. The present invention also has a percentage match feature that indicates the percentage of a candidate matches to the recruiter and vice versa on their profile cards. This will be to give the recruiter and candidate a better idea of a good match. The percentage match is evaluated via variables of “personality, culture fit, soft skills, hard skills, and experience, and is subject to change. This will also be a data collection mechanism as if they often reject who we think of a good match. The present invention uses the intelligence to give better matches to both the recruiter and the talent user.

In yet another embodiment of the present invention, the system processing unit utilizes the data from the the at least one database unit (swiping data, role information, company information, etc.) to provide accurate suggestions to the startup recruiter hiring to better inform them of the technical abilities of a candidate.

In yet another embodiment of the present invention, the system processing unit uses artificial intelligence to group the connected/matched candidates into categories, after swiping and matching, for easier management of the possible candidates, and similar method is used by the candidate to group the connected/matched recuiters and companies.

In yet another embodiment of the present invention, there is also a “Discover” page with a stream of media content (this is mostly text-based articles, can be audio/video media as well). This Discover page is an aggregated list that shows the user (both candidate and recruiter) content from a set of predefined sources and directs them to the source. The processing unit automatically index and feed the database unit articles from places like, but not limited to, Medium or LinkedIn. The processing unit then categorize these articles. Discover Page then retrieves certain articles from the the database unit to display to the user. The processing unit make this query to get articles based on categories that the user will be interested in through artificial intelligence. If a user taps on an article, they are directed to where the article is found.

Further objectives, advantages, and features of the present invention will become apparent from the detailed description provided herein, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

I/We claims

1. A system(100) and method for recruiting resources using a personality based matching platform, the system(100) comprising:
an at least one cloud server computer(102), the at least one cloud server computer(102) having
an at least one database unit(104), the at least one database unit(104) stores computer-readable instructions, data of talent users, and data of recruiters, and
a system processing unit(106), the system processing unit(106) executes an computer-readable instructions that keep on continuously improving by learning through data of the talent users, and data of the recruiters;
an at least one talent user device(110), the at least one talent user device(110) stores computer-readable instructions that is executed by the at least one talent user device(110) to communicates with the system processing unit(106) of the at least cloud server computer(102), the at least one talent user device(110) having a talent device touch screen(112); and
an at least one recruiter device(114), the at least one recruiter device(114) stores computer-readable instructions that is executed by the at least one recruiter device(114) to communicates with the system processing unit(106) of the at least cloud server computer(102), the at least one recruiter device(114) having a recruiter device touch screen(116);
wherein, the at least one talent user device(110) communicates the data of talent user to be stored in the at least one database unit(104) of the at least cloud server computer(102) and the system processing unit(106) executes computer-readable instructions that uses data of talent user as variable to generate the talent user profile card, and further based on the talent user profile card, the system processing unit(106) executes computer-readable instructions to search for the suitable recruiters,
wherein, the at least one recruiter device(114) communicates data of recruiters to be stored in the at least one database unit(104) of the at least cloud server computer(102) and the system processing unit(106) executes computer-readable instructions that uses data of recruiters to generate a recruiter job profile card and as well as a recuiter company profile card, and based on the recruiter job profile card and the recuiter company profile card, the system processing unit(106) executes computer-readable instructions to search for the suitable talent user,
wherein, the system processing unit(106) executes computer-readable instructions to send suitable the recruiter job profile card and the recuiter company profile card to be displayed on the talent device touch screen(112), and further the system processing unit(106) executes computer-readable instructions to send the talent user profile card to be displayed on the recruiter device touch screen(116),
wherein, both the talent user and the recruiter approves each other by swiping the each other profile card on their respective the talent device touch screen(112) and the recruiter device touch screen(116), and after approval from both the talent user and recruiter, then both party is able to be converse over in-built message application and proceed for further for completing recruitment process, thus the talent user and recruiter have one to one interaction.

2. The system(100) as claimed in claim 1, wherein, system(100) and method of recruiting also includes holistic assessments of a candidate based on factors selected from , a technical scopes of the role, culture fit, etc.

3. The system(100) as claimed in claim 1, the system processing unit(106) executes an artificial based computer-readable instructions to generate the talent user profile card, the recruiter job profile card and the recuiter company profile card, search suitable recruiter job profile card for the at least one talent user device(110) and search for suitable the talent user profile card for the at least one recruiter device(114)

4. The system(100) as claimed in claim 1, wherein the at least cloud server computer(102) is selected from a desktop computer, a server, a main frame computer.

5. The system(100) as claimed in claim 1, wherein the at least one talent user device(110) and the at least one recruiter device(114) are selected from a tablet, a smartphone, and a touch based personal computer.

6. The system(100) as claimed in claim 1, wherein the system processing unit(106) utilizes the data from the the at least one database unit(104) (swiping data, role information, company information, etc.) to provide accurate suggestions to the startup recruiter hiring to better inform them of the technical abilities of a candidate.

7. The system(100) as claimed in claim 1, wherein the system processing unit(106) uses artificial intelligence to group the connected/matched candidates into categories, after swiping and matching, for easier management of the possible candidates, and similar method is used by the candidate to group the connected/matched recuiters and companies.

8. A method for recruiting resources using a personality based matching platform, the method comprising:
a method of a talent user profile card generation, the method having
a talent user creates a digital account on an at least one cloud server computer(102) with the help of an at least one recruiter device(114),
after creation of the digital account, a talent device touch screen(112) display data that needs to be fill in order to generate the talent user profile card, wherein, the information includes a profile picture,
university/company, the three words the talent user uses to describe themselves, the type of position the talent user are seeking,
the talent user fill up the information on a talent device touch screen(112) and the at least one recruiter device(114) communicates data of the talent user to be stored in the at least one database unit(104) of the at least cloud server computer(102) and
further, the talent user is able to upload a 25 second elevator pitch video on the at least one database unit(104), and
thus, the system processing unit(106) executes computer-readable instructions that uses data of talent user as variable to generate the talent user profile card;
wherein, the system processing unit(106) uses natural language processing to extract data from 25 second elevator pitch video of the talent user and further uses that data to generate the talent user profile card;
a method of a recruiter profile card generation, the method having
a recruiter creates a digital account on an at least one cloud server computer(102) with the help of an at least one recruiter device(114),
after creation of the digital account, a recruiter device touch screen(116) display data that needs to be fill in order to generate a recruiter job profile card, wherein recruiter is able to generate multiple recruiter job profile based on different job role requirements,
the at least one recruiter device(114) communicates data of recruiters to be stored in the at least one database unit(104) of the at least cloud server computer(102), and
the system processing unit(106) executes computer-readable instructions that uses data of recruiters to generate the recruiter job profile card;
a method of a recruiter company profile card generation, the method having
a recruiter creates a digital account on an at least one cloud server computer(102) with the help of an at least one recruiter device(114),
after creation of the digital account, a recruiter device touch screen(116) display data that needs to be fill in order to generate a recruiter company profile card,
the at least one recruiter device(114) communicates data of company to be stored in the at least one database unit(104) of the at least cloud server computer(102), and
the system processing unit(106) executes computer-readable instructions that uses data of company to generate the recruiter company profile card;
a method of searching creating match between talent user and recruiter, the method having
the system processing unit(106) executes computer-readable instructions to send suitable the recruiter job profile card to be displayed on the talent device touch screen(112), that matched the talent user personality and skills,
further the system processing unit(106) executes computer-readable instructions to send the talent user profile card to be displayed on the recruiter device touch screen(116) based on the job role requirement,
both the talent user and the recruiter approves each other by swiping the each other profile card on their respective the talent device touch screen(112) and the recruiter device touch screen(116), and after approval from both the talent user and recruiter, then both party is able to be converse over in-built message application and proceed for further for completing recruitment process, thus the talent user and recruiter have one to one interaction.
the talent user also able to check the recruiter company profile card associated with the recruiter job profile card on the talent device touch screen(112);
wherein, the system processing unit(106) uses an artificial based algorithm to search suitable recruiter job profile card for the at least one talent user device(110) and search for suitable the talent user profile card for the at least one recruiter device(114).
wherein artificial based algorithm uses skills, keywords, past experience and industry to search suitable recruiter job profile card for the at least one talent user device(110) and search for suitable the talent user profile card for the at least one recruiter device(114).

9. The method as claimed in claim 6, wherein card swiping pattern data is being used by the system processing unit(106) of the at least one cloud server computer(102) to improve the artificial based algorithm to search suitable recruiter job profile card for the at least one talent user device(110) and search for suitable the talent user profile card for the at least one recruiter device(114).

10. The method as claimed in claim 6, wherein a unique artificial based algorithm is catered to the at least one recruiter device(114) that allows recruiter to define how important each of these factors are to recruiter to select the talent user and based on that factors algorithm is. tweaked to allow matching with importance given to skills in the matching process.
